(19) United States
(12) Patent Application Publication
(10) Pub. No.: US 2012/0122060 A1
(43) Pub. Date: May 17, 2012

(54) WEIGHT LOSS METHOD AND SYSTEM FOR PERFORMING AND MONITORING THE SAME

(75) Inventors: Tiffany Strobel, Salt Lake City, UT (US); Nathalie Chevreau, Salt Lake City, UT (US); Mitch Friedlander, Salt Lake City, UT (US)

(73) Assignee: WESTERN HOLDINGS, LLC, Carson City, NV (US)

(21) Appl. No.: 13/356,415

(22) Filed: Jan. 23, 2012

Related U.S. Application Data
(62) Division of application No. 12/706,757, filed on Feb. 17, 2010.

(51) Int. Cl. G09B 19/00

(52) U.S. Cl. 434/127

(57) ABSTRACT

Methods and systems of establishing a program to maximize weight loss include determining an energy deficiency and an exercise regimen for a particular female individual based on an increased concentration or level of at least one ovarian hormone, such as an oestrogen or progesterone. The increased concentration of the at least one ovarian hormone may be determined by calculating a phase of a menstrual cycle of the female subject. The daily energy deficiency may be calculated and an exercise regimen determined based on the phase of the menstrual cycle. By decreasing the daily energy deficiency and increasing the exercise regimen while the concentration of at least one ovarian hormone is increased, weight loss (i.e., fat loss) may be maximized.

### CROSS-REFERENCE TO RELATED APPLICATION

This application is a divisional of U.S. patent application Ser. No. 12/706,757, filed Feb. 17, 2010, pending, the disclosure of which is hereby incorporated herein by this reference in its entirety.

### TECHNICAL FIELD

Embodiments of the invention generally relate weight loss in female individuals and, more specifically, to methods and systems for establishing a weight loss regimen in female individuals.

### BACKGROUND

The prevalence of obesity is increasing globally. Obese individuals are combating a homeostatic biological system that seems to be extremely effective in maintaining the obese state. Achievement and maintenance of weight loss in obese individuals have proven difficult. Many hypotheses have raised potential biological mechanisms to explain why weight loss attempts often fail and the surrounding obesogenic environment also seems an obvious candidate. Among the biological factors proposed is gender, and weight loss trials have frequently shown that females are less successful than males at losing weight and at maintaining a weight loss.

Women's weight is influenced by the menstrual cycle, in which changes in hormonal levels and interactions work to modulate fertility. These hormones control the menstrual cycle and coordinate the required changes in energy intake, expenditure, and storage, while preparing the body for pregnancy every month. As reproduction is a primary biological function, these hormones may be such strong mediators of eating behavior that they influence the outcome of a weight loss attempt. The menstrual cycle should, therefore, be taken into consideration as a factor in the physiology of energy balance in premenopausal women.

The cycle can be divided into three phases: a menstruation or early follicular phase (approximately days 1-5), a late follicular phase that lasts until ovulation (approximately days 6-14), and luteal phase (approximately days 15-28). Studies have shown that in the luteal phase of the menstrual cycle, women's energy intake and energy expenditure are increased and women experience more frequent cravings for foods, particularly those high in carbohydrate and fat, than during the follicular phase. A trend towards reduced carbohydrate utilization and increased fat oxidation in the luteal phase has also been reported, together with prolonged time to exhaustion when exercising at submaximal intensities. This suggests that the potential of the underlying physiology related to each phase of the menstrual cycle may be worth considering as an element in strategies to optimize weight loss.

In view of the above, there is a need in the art for methods and systems of determining a weight loss regimen for women based on the menstrual cycle.

### BRIEF SUMMARY

Various embodiments of the present invention include methods that may be used to establish a weight loss program for a female individual. The methods may include determining a phase of a menstrual cycle and calculating an energy intake based on the phase of the menstrual cycle. The menstrual cycle may include a menstruation phase, a follicular phase, and a luteal phase. An energy deficiency during the luteal phase may be calculated to be greater than an energy deficiency during the menstruation phase and the follicular phase. For example, the energy deficiency may be about 800 k/cal during the first five days of the luteal phase and may be about 200 k/cal during a last seven days of the luteal phase.

Methods of altering actual weight in a female individual are also provided. Such methods may include determining an increase in a concentration of at least one hormone selected from the group comprising estrogens and progesterone and preparing at least one of a dietary regimen and an exercise regimen based on the increased in concentration of at least one such hormone.

In yet other embodiments, the present invention includes methods of treating weight gain in a female individual that include determining a daily energy usage in a female individual, determining at least one phase of a menstrual cycle in the female individual and using the at least one phase of the menstrual cycle to determine a daily energy intake and exercise regimen for the female individual.

### DETAILED DESCRIPTION OF THE INVENTION

The term “menstrual cycle” means and includes a recurring cycle of physiological changes in females that is associated with reproductive fertility. While the cycle length may vary from woman to woman, 28 days is generally taken as representative of the average ovulatory cycle in women. For the purpose of this invention, the onset of menstrual bleeding marks the beginning of the cycle, so the first day of bleeding is also referred to as the first day of the cycle.

As used herein, the term “menstrual phases” or “phases” means and includes one of three phases: a menstruation phase (days 1-5), a follicular phase (days 6-14), and a luteal phase (days 15-28).

The term “energy usage,” as used herein, means and includes a caloric amount of energy expended by a body of an individual while that individual is at rest.

The term “energy deficiency,” as used herein, means and includes a caloric amount by which the energy usage may be reduced.

The term “energy intake,” as used herein, means and includes a caloric amount equal to the energy usage minus the energy deficiency.

The term “body mass index” or “BMI,” as used herein, means and includes the difference between the fat mass and non-fat mass of the body and is most often expressed as parameter derived from dividing an individual's body weight by the square of the individual's height. In other words, the BMI is used to determine an amount of body fat and is a standard means of measuring obesity. An adult who has a BMI of between 19 and 24.9 is generally considered normal, a BMI of between 25 and 29.9 is generally considered overweight, and a BMI of 30 or higher is generally considered obese.

As used herein, the term “macronutrient composition” means and includes the proportions of fat, protein, and carbohydrate in the daily energy intake.

The term “waist circumference,” as used herein, means and includes a measure of abdominal fat content. The waist circumference of an individual is commonly determined using a tape measure placed comfortably around the smallest area below the rib cage and above the umbilicus (i.e., belly button). Alternatively, the waist circumference may be measured at the natural waist, between the palpated iliac crest and the palpated lowest rib margin at the mid axillary line.

The phase of the menstrual cycle may be determined by detecting a level of one or more hormones in the female individual, such as, for example, luteinizing hormone, follicle-stimulating hormone, progesterone, and estradiol. An ovulation test may be used to determine the termination of the follicular phase and the beginning of the luteal phase as women's cycle may deviate from the average 28 days. By way of non-limiting example, an over-the-counter ovulation test kit, such as the CLEARBLUE EASY digital ovulation test, may be used to determine the level of luteinizing hormone from day six (6) of the menstrual cycle (i.e., the beginning of the follicular phase) until a positive indication of ovulation is detected.

Daily energy intake and macronutrient composition of the diet may be varied in order to match cyclic changes in the body's energy demands during the three phases. Additionally, the women will be put on an exercise regimen designed to optimize the ability to burn fat or increase muscle mass by adjusting the intensity, duration, frequency and type of physical activity throughout the three menstrual phases.

A diet and exercise regimen will be adjusted corresponding to one or more phases of the menstrual cycle (i.e., approx. 1 month) and will be separated into three phases corresponding to the three menstrual phases: a menstruation phase (days 1-5), a follicular phase (days 6-14), and a luteal phase (days 15-28). By way of example, the diet and exercise regimen may begin on the first day of the menstrual cycle (i.e., the first day of the menstruation phase), and may be repeated about six (6) times (i.e., about six (6) months). A total energy intake per month may be about 17,000 kcal.

To establish a daily energy usage before weight loss, a basal metabolic rate for the female individual may be calculated using the Mifflin-St Jeor equation which is as follows:

BMR=9.99(weight in kilograms)+6.25(height in centimeters)−4.92(age)−161.

The BMR may be multiplied by an activity factor of between about 1.2 and about 1.5 and, more particularly, about 1.4, to reflect the female individual's typical activity level before the study. Based on the phase of the cycle, an energy deficiency may be determined and may be subtracted from the energy usage to calculate an energy intake for the female individual. The female individual may be provided with oral and written instructions of the energy percent distribution that they need to follow for each phase of the menstrual cycle.

Additionally, a computer-based system for monitoring and improving the user's compliance by providing the user with detailed instruction and feedback may also be utilized. The system may include a processing means for calculating an energy intake and exercise regimen based on a phase of the user's menstrual cycle and generating a message comprising the energy intake and the exercise regimen. The system may accept and store the input, such as energy intake and exercise and may calculate whether the user is achieving their goal. The computer-based system may further assist the female individual with weight loss compliance by determining macronutrient content of the energy intake, building menus and providing feedback and reminders.

A level (i.e., frequency and intensity) of physical activity may be determined based on a phase of the menstrual cycle. For example, a level of physical activity may be substantially increased or accelerated during the last four days of the follicular phase (i.e., approximately days 11-14 of the menstrual cycle) and during the luteal phase, while levels of hormones such as estradiol, progesterone, luteinizing hormone and follicle-stimulating hormone are substantially increased. As a non-limiting example, the female individual may be instructed to perform about 30 minutes of moderate to heavy exercise in addition to 30 minutes of resistance training at least every second (i.e., every other) day during the last four days of the follicular phase (i.e., approximately days 11-14 of the menstrual cycle) and during the luteal phase. During the menstrual phase (i.e., approximately days 1-5 of the menstrual cycle), the female individual may be instructed to perform about 1 hour of light exercise every two days. The female individual may be instructed to performed about 1 hour of resistance training and about 1 hour of light exercise at regular intervals during the follicular phase (i.e., approximately days 6-14 of the menstrual cycle). Light exercise generally allows you to talk while an individual exercises. Examples of light exercise include, for example, low intensity physical activity, going for a walk, doing some light housework, or gardening. Moderate exercise generally involves a moderate level of activity that noticeably increases an individual's heart rate and breathing rate. An individual may sweat, but is still able to carry on a conversation. Moderate intensity exercise includes walking at a rate of between 91 and 115 steps per minute.

During the menstruation phase, a daily energy deficiency may be about 500 kcal. The female individual may perform about 1 hour of physical activity at least two times during this phase. On days where physical activity is performed, the female individual may be instructed to consume more energy so that the daily energy deficiency does not exceed about 500 kcal. The macronutrient composition of the energy intake during the menstruation phase may include between about 50% and about 60% carbohydrate, less than 30% fat, and between about 10 and about 20% protein.

The physical activity during the menstruation phase may be light activity such as walking, jogging, biking, swimming, etc. An amount of energy used when engaging in physical activity can be assessed by means of heart rate monitors, such as an F11 heart rate monitor available from Polar Electro Oy Corporation (Kempele, Finland), which can also calculate calories expended or used by the female individual during exercise.

During the follicular phase, the daily energy deficiency may be about 800 kcal. While not wishing to be bound by any particular theory, it is believed that the plasma level of estrogen is increased during the follicular phase, and may serve to suppress appetite. As in the menstrual phase, the individual may be instructed to consume more energy on days where they engage in physical activity so that the daily energy deficiency does not exceed about 800 kcal.

In this phase it may be beneficial to include resistance training, as the body's potential for improving strength may be enhanced around ovulation. Women will have to engage in about 1 hour of resistance training, four times, corresponding to every third day of this phase. Additionally, the female individual may perform some light exercise such as, for example, walking, jogging, biking, swimming, and the like, for about 1 hour, two times during this phase.

The daily amount of protein in the macronutrient composition of the energy intake may be increased during the follicular phase to optimize the body's response to the resistance training. The amount of protein may be adjusted by increasing the amount of calories obtained from protein, and accordingly reducing the amount of calories obtained from both fat and carbohydrate. The macronutrient composition of the energy intake during the menstruation phase may include between about 45% and about 60% carbohydrate, between about 20% and about 30% protein, and less than or equal to about 20% fat. While not bound by any particular theory, the increased contribution from protein to the total energy intake in this phase may help to increase satiety in order to maintain adherence to the higher daily energy deficiency in this phase.

During the first six days (i.e., days 15 to 20) of the luteal phase, the daily energy deficiency may be about 800 kcal. After that (i.e., days 21 to 28), the daily energy deficiency may be about 200 kcal. Without wishing to be bound to any particular theory, it is believed that a reduced energy deficiency may help to prevent increases in appetite and food cravings, each of which has been reported have increased frequency and increased severity throughout this phase and, in particular, about 4 to about 7 days before the onset of the menstruation phase, in comparison with the other phases of the menstrual cycle, possibly because the energy demand is increased in this phase. There will be an option for intake of from between about 1 oz. and about 4 oz., and more particularly, about 2 oz. of chocolate and more particularly, dark chocolate, per day.

The macronutrient composition during the luteal phase may be altered in order to meet the increased appetite and cravings. For example, the macronutrient content may include between about 40% and about 50% carbohydrate, between about 25% and about 30% fat, and about 20% to about 30% protein.

In the luteal phase, both plasma estrogen and progesterone are elevated. Without wishing to be bound to any theory, increased progesterone levels may result in substantially increased energy expenditure and the ability to burn fat may also increased. Thus, the frequency of physical activity may be increased to every second (i.e., every other) day during the luteal phase. Such exercise may be performed for about 30 minutes at the highest submaximal intensity possible (i.e., between about 60% and about 80% of VO₂ max). After completing the endurance training another 30 minutes of resistance training should be performed. Resistance training includes any training that uses a resistance to force of muscular contraction and works to increase muscle strength and endurance by doing repetitive exercises, such as, for example, with weights, weight machines, or resistance bands.

### EXAMPLES

### Example 1

### Comparative Example

Premenopausal, female subjects between the ages of eighteen (18) and forty (40) with a BMI of between 25-30 kg/m2, inclusive, who are not taking hormonal contraceptives, and who have regular menstrual cycles may begin a weight loss program. Subjects may be given a 12-day ovulation kit and may be provided with instructions on its use. The purpose is to monitor the menstrual cycle of each subject. The subjects may demonstrate a regular menstrual cycle. Baseline measurements such as, for example, weight, height, bone density, BMI, waist circumference, questionnaires, and a whole body DEXA, may be performed about 1 day to about 5 days prior to the target menstrual cycle of the subject. On Day 1 of their target menstrual cycle, subjects may begin the program described in detail in Table 1.

TABLE 1

| Program A | | | |
|---|---|---|---|
| | Energy | | Energy |
| Days | Deficiency | Physical exercise | Breakdown |
| 1 | 500 kcal | 1 hour light exercise | ~50% to ~60% |
| | | | carbohydrate |
| 2 | 500 kcal | | Less than ~30% % fat |
| 3 | 500 kcal | 1 hour light exercise | ~10% to ~20% |
| | | | protein |
| 4 | 500 kcal | | |
| 5 | 800 kcal | 1 hour resistance training | |
| 6 | 800 kcal | | ~45% to ~55% |
| | | | carbohydrate |
| 7 | 800 kcal | 1 hour light exercise | Less than ~20% fat |
| 8 | 800 kcal | 1 hour resistance training | ~30% to ~30% |
| | | | protein |
| 9 | 800 kcal | | |
| 10 | 800 kcal | | |
| 11 | 800 kcal | 1 hour resistance training | |
| 12 | 800 kcal | 1 hour light exercise | |
| 13 | 800 kcal | | |
| 14 | 800 kcal | 1 hour resistance training | |
| 15 | 800 kcal | | |
| 16 | 800 kcal | 30 minutes moderate to | ~45% to ~55% |
| | | heavy exercise/30 minutes | carbohydrate |
| | | resistance training | |
| 17 | 800 kcal | | Less than ~20% fat |
| 18 | 800 kcal | 30 minutes moderate to | ~20% to ~30% |
| | | heavy exercise/30 minutes | protein |
| | | resistance training | |
| 19 | 800 kcal | | |
| 20 | 800 kcal | 30 minutes moderate to | |
| | | heavy exercise/30 minutes | |
| | | resistance training | |
| 21 | 800 kcal | | |
| 22 | 200 kcal | 30 minutes moderate to | ~55% to ~65% |
| | | heavy exercise/30 minutes | carbohydrate |
| | | resistance training | |
| 23 | 200 kcal | 1 hour resistance training | ~25% to 30% fat |
| 24 | 200 kcal | 30 minutes moderate to | ~10% to 15% |
| | | heavy exercise/30 minutes | protein |
| | | resistance training | |
| 25 | 200 kcal | | 2 oz dark chocolate |
| | | | per day |
| 26 | 200 kcal | 30 minutes moderate to | |
| | | heavy exercise/30 minutes | |
| | | resistance training | |
| 27 | 200 kcal | 1 hour light exercise | |
| 28 | 200 kcal | | |

A baseline basal metabolic rate may be calculated using the Mifflin-St Jeor equation which will be then multiplied by an activity factor that reflects the subject's typical activity level before the beginning the program. This may be used to determine the daily energy usage before weight loss. Subjects' energy intake for their ideal body weight will be calculated according to Table 1. On day 1 of their target menstrual cycle (i.e., the first day of the menstruation phase), subjects will begin the program. In the first month, subjects may be instructed to alter their energy intake and expenditure at the transition between phases of the menstrual cycle (i.e., menstruation to follicular and then follicular to luteal). This may occur from between about 0 days and about 3 days prior to the transition between phases.

Each female individual may be involved in the program for between about 5 months to about 30 months. The baseline measurements may be obtained throughout the program, for example, from about 4 to about 11 times. The measurements may be performed on the female subject at regular intervals, for example, as follows: at screening, baseline, weeks 4, 8, 12, 16, 20, and 24, all ±5 days. There may also be a follow-up measurement between about 1 month and about 1 year after completion of the program. Complete testing of multiple subjects may be performed in a stagger-start manner. The daily energy deficiency during the program and the physical activity may result in an average energy intake by the subject of about 17,000 kcal/month.

### Example 2

### Comparative Example

Premenopausal, female subjects between the ages of eighteen (18) and forty (40) with a BMI of between 25-30 kg/m2, inclusive, who are not taking hormonal contraceptives, and who have regular menstrual cycles may be studied. The female subject's menstrual cycle may be determined and baseline measurements may be performed on the female subjects from between about 0 days and about 5 days prior to initiation of the program described in Table 2. Subjects may begin the program at a random time in their cycle. A baseline basal metabolic rate may be calculated using the Mifflin-St Jeor equation which will be then multiplied by an activity factor that reflects the subject's typical activity level before the study to determine the daily energy usage before weight loss. A daily energy deficiency of 600 kcal will remain constant throughout the program, as shown in Table 2. On days where physical activity is performed, the women may be instructed to increase the energy intake to ensure that the daily energy deficiency gets as close to the recommended 600 kcal/day as possible. The amount of energy used when engaging in physical activity may be assessed by means of heart rate monitors, such as an F11 heart rate monitor, which may also calculate calories burned and may also work to enhance motivation for exercising as subjects can keep track of their effort.

No changes should be made in daily energy deficiency and diet composition (energy percent distribution) or in the amount of the physical activity throughout 24 weeks. The daily energy deficiency should correspond to a weekly weight loss of about 0.5 kg to about 1 kg per week.

Women may exercise 10 times within 4 weeks. The type of exercise may vary, as long as approximately 300 kcal are utilized each time. The daily energy deficiency during the program and the physical activity may result in an average energy intake by the subject of about 17,000 kcal/month.

Program B

| | Energy | |
|---|---|---|
| Days | Deficiency | Physical exercise |
| 1 | 600 kcal | |
| 2 | 600 kcal | Exercise of individual |
| | | choice until 300 kcal are |
| | | burned |
| 3 | 600 kcal | |
| 4 | 600 kcal | Exercise of individual |
| | | choice until 300 kcal are |
| | | burned |
| 5 | 600 kcal | |
| 6 | 600 kcal | |
| 7 | 600 kcal | Exercise of individual |
| | | choice until 300 kcal are |
| | | burned |
| 8 | 600 kcal | |
| 9 | 600 kcal | |
| 10 | 600 kcal | |
| 11 | 600 kcal | Exercise of individual |
| | | choice until 300 kcal are |
| | | burned |
| 12 | 600 kcal | |
| 13 | 600 kcal | Exercise of individual |
| | | choice until 300 kcal are |
| | | burned |
| 14 | 600 kcal | |
| 15 | 600 kcal | |
| 16 | 600 kcal | Exercise of individual |
| | | choice until 300 kcal are |
| | | burned |
| 17 | 600 kcal | |
| 18 | 600 kcal | Exercise of individual |
| | | choice until 300 kcal are |
| | | burned |
| 19 | 600 kcal | |
| 20 | 600 kcal | |
| 21 | 600 kcal | Exercise of individual |
| | | choice until 300 kcal are |
| | | burned |
| 22 | 600 kcal | |
| 23 | 600 kcal | Exercise of individual |
| | | choice until 300 kcal are |
| | | burned |
| 24 | 600 kcal | |
| 25 | 600 kcal | |
| 26 | 600 kcal | Exercise of individual |
| | | choice until 300 kcal are |
| | | burned |
| 27 | 600 kcal | |
| 28 | 600 kcal | |

Specific embodiments have been shown by way of example in the drawings and have been described in detail herein. The invention, however, may be susceptible to various modifications and alternative forms. It should be understood that the invention is not intended to be limited to the particular forms disclosed. Rather, the invention includes all modifications, equivalents, and alternatives falling within the spirit and scope of the invention as defined by the following appended claims.

We claim:

1. A method of altering actual weight in a premenopausal female individual, comprising:
determining an increase in a concentration of at least one hormone selected from the group comprising estrogens and progesterone; and
preparing at least one of a dietary regimen and an exercise regimen based on the increased in concentration of the at least one hormone.

2. The method of claim 1, wherein determining an increase in a concentration of at least one hormone selected from the group comprising estrogens and progesterone comprises detecting a phase of a menstrual cycle of the female individual, the menstrual cycle comprising a menstruation phase, a follicular phase, and a luteal phase.

3. The method of claim 2, wherein detecting a phase of the menstrual cycle of the female individual comprises detecting a level of luteinizing hormone (LH) to determine ovulation, wherein ovulation occurs at an interface of the follicular phase and the luteal phase.

4. The method of claim 3, wherein detecting a phase of a menstrual cycle of the female individual comprises calculating the menstrual cycle to comprise about 28 days, the menstruation phase comprising (the first 5 days) days 1 to 5, the follicular phase comprising days 6 to 14, and the luteal phase comprising days 15 to 28.

5. The method of claim 1, wherein preparing at least one of a dietary regimen and an exercise regimen based on the increased in concentration of the at least one hormone based on the phase of the female's menstrual cycle comprises determining a energy deficiency based on an increase in concentration of at least one hormone.

6. The method of claim 5, wherein determining a energy deficiency based on an increase in concentration of at least one hormone comprises calculating a daily energy deficiency of about 200 kcal/day during the increase in the concentration of the at least one hormone.

7. The method of claim 1, wherein preparing at least one of a dietary regimen and an exercise regimen based on the increased in concentration of the at least one hormone based on the phase of the female's menstrual cycle comprises determining an increased exercise regimen during the increased in the concentration of the at least one hormone.

8. A method of determining a weight loss program for a premenopausal female individual, comprising:
determining a level of at least one hormone selected from the group consisting of leutinizing hormone, follicle-stimulating hormone, progesterone, and estradiol;
planning a daily energy intake and exercise regimen based on the level of the at least one hormone.
